(19) United States
(12) Patent Application Publication
(10) Pub. No.: US 2026/0158863 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Yong Woong Cha, Hwaseong-si (KR); Jungha Park, Hwaseong-si (KR); Man Hee Park, Hwaseong-si (KR); Joongsu Yun, Hwaseong-si (KR); Hoyoung Jeong, Hwaseong-si (KR)

(73) Assignees: HYUNDAI MOTOR COMPANY, Seoul (KR); KIA CORPORATION, Seoul (KR)

(21) Appl. No.: 19/288,677

(22) Filed: Aug. 1, 2025

(30) Foreign Application Priority Data
Dec. 6, 2024 (KR) 10-2024-0181006

(51) Int. Cl. B60H 1/00; B60H 1/32; F25B 9/00; F25B 30/02; F25B 41/31

(52) U.S. Cl. CPC B60H 1/00899; B60H 1/00278; B60H 1/3228; F25B 9/008; F25B 30/02; F25B 41/31

(57) ABSTRACT

A heat pump system for a vehicle is capable of performing cooling or heating of a vehicle interior by using a natural refrigerant in compliance with environmental regulations, and by efficiently adjusting the temperature of the battery module by using a single chiller where a refrigerant and a coolant heat-exchange each other. The heat pump system is capable of maximizing the cooling and heating performance by operating in the supercritical cycle, in which the pressure and temperature of the refrigerant is higher than a critical pressure and temperature, by applying R744 refrigerant, which is a natural refrigerant utilizing carbon dioxide.

### CROSS-REFERENCE TO RELATED APPLICATION

This application claims priority to and the benefit of Korean Patent Application No. 10-2024-0181006, filed with the Korean Intellectual Property Office on Dec. 6, 2024, the entire contents of which is incorporated herein by reference.

### BACKGROUND OF THE DISCLOSURE

### Technical Field

The present disclosure relates to a heat pump system for a vehicle, and more particularly, the present disclosure relates to a heat pump system for a vehicle capable of performing cooling or heating of a vehicle interior.

### Description of the Related Art

An air conditioning system for a vehicle includes an air conditioner unit circulating a refrigerant in order to heat or cool an interior of a vehicle.

The air conditioner unit, which maintains the interior of a vehicle at an appropriate temperature regardless of a change in an external temperature to maintain a comfortable interior environment, is configured to heat or cool the interior of a vehicle by heat-exchange by a condenser and an evaporator in a process in which a refrigerant discharged by driving of a compressor is circulated back to the compressor through the condenser, a receiver drier, an expansion valve, and the evaporator.

The air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

An environment-friendly technology of a vehicle is a core technology of a future automobile industry, and advanced car makers have focused their energy on the development of an environmentally-friendly vehicle to achieve environmental and fuel efficiency regulations.

In accordance with a continuous increase in interest in energy efficiency and an environmental pollution problem, the development of an environmentally-friendly vehicle capable of substantially substituting for an internal combustion engine vehicle is required, and the environmentally-friendly vehicle is classified into an electric vehicle driven using a fuel cell or electricity as a power source and a hybrid vehicle driven using an engine and a battery.

The electric vehicle is in the spotlight as a means of transportation in the future to solve environment problems and energy resource problems.

A heat pump system, which is an air conditioner apparatus for regulating the temperature of a vehicle interior, is applied to such an electric vehicle.

However, the refrigerant that is conventionally used in the heat pump system contains a large amount of environmentally regulated material, e.g., PFAS (Per-and Polyfluoroalkyl Substances), and therefore, there is a demand for the development of a system capable of controlling the temperature of the vehicle interior by using new refrigerants from without PFAS and flammability, or natural refrigerants.

The above information disclosed in this Background section is only for enhancement of understanding of the background of the disclosure, and therefore it may contain information that does not form the prior art that is already known to one having ordinary skill in the art.

### SUMMARY OF THE DISCLOSURE

The present disclosure provides a heat pump system for a vehicle capable of performing cooling or heating of a vehicle interior by using a natural refrigerant in compliance with environmental regulations, and by efficiently adjusting the temperature of the battery module by using a single chiller where a refrigerant and a coolant heat-exchange each other.

In addition, the present disclosure provides a heat pump system for a vehicle capable of maximizing the cooling and heating performance by operating in the supercritical cycle, in which the pressure and temperature of the refrigerant is higher than a critical pressure and temperature, by applying R744 refrigerant, which is a natural refrigerant utilizing carbon dioxide.

A heat pump system for a vehicle includes a compressor, a first heat-exchanger, a second heat-exchanger, a first expansion valve, and a third heat-exchanger, which are connected through the refrigerant line to circulate the refrigerant. The heat pump system further includes a first connection line having a first end connected to the refrigerant line connecting the second heat-exchanger and the first expansion valve, and a second end connected to the refrigerant line connecting the third heat-exchanger and the compressor. The heat pump system further includes a chiller provided on the first connection line, and configured to adjust a temperature of the coolant by heat-exchanging the supplied refrigerant with a coolant. The heat pump system further includes a second expansion valve provided on the first connection line between a first end of the first connection line and the chiller. The heat pump system further includes a second connection line having a first end connected to the refrigerant line between the first heat-exchanger and the second heat-exchanger, and a second end connected to the first connection line between a second end of the first connection line and the chiller. The heat pump system further includes a third connection line having a first end connected to the refrigerant line between the compressor and the first heat-exchanger, and a second end connected to the refrigerant line between the first heat-exchanger and the second heat-exchanger.

The heat pump system may further include a first valve provided on the refrigerant line between the compressor and the first heat-exchanger, a second valve provided on the refrigerant line between the first heat-exchanger and the second heat-exchanger, a third valve provided on the first connection line between the second end of the first connection line and the chiller, a third expansion valve provided on the second connection line, and a fourth valve provided on the third connection line.

The heat pump system may further include a fourth connection line having a first end connected to the refrigerant line between the third heat-exchanger and the compressor, and a second end connected to the refrigerant line between the second valve and the second heat-exchanger, and a fifth valve provided on the fourth connection line.

When a battery module is to be cooled in a cooling mode of a vehicle interior, a portion of the refrigerant line connecting the compressor and the first heat-exchanger, and a portion of the refrigerant line connecting the first heat-exchanger and a second end of the third connection line may be closed by the first valve. The remaining portion of the refrigerant line connecting the second end of the third connection line to the second heat-exchanger, the third heat-exchanger, and the compressor may be opened by the second valve and the first expansion valve. The first connection line may be opened by the second expansion valve and the third valve, the second connection line may be closed by the third expansion valve, the third connection line may be opened by the fourth valve, and the fourth connection line may be closed by the fifth valve.

The first expansion valve may allow the introduced refrigerant to flow in an expanded state. The second expansion valve may allow the introduced refrigerant to flow in an expanded state so that the battery module may be cooled by using the coolant heat-exchanged with the refrigerant in the chiller. The refrigerant discharged from the compressor may be introduced into the second heat-exchanger along the third connection line and the opened refrigerant line. A partial refrigerant among the refrigerant discharged from the second heat-exchanger may be introduced into the chiller along the first connection line. A remaining refrigerant among the refrigerant discharged from the second heat-exchanger may be introduced into the first expansion valve along the refrigerant line. The refrigerant discharged from the chiller, and the refrigerant discharged from the third heat-exchanger may be supplied to the compressor along the refrigerant line.

In a cooling-and-dehumidifying mode of a vehicle interior, the refrigerant line connecting the compressor, the first heat-exchanger, the second heat-exchanger, the first expansion valve, and the third heat-exchanger may be opened by the first valve, the second valve, and the first expansion valve. The first connection line may be closed by the second expansion valve and the third valve. The second connection line may be closed by the third expansion valve. The third connection line may be closed by the fourth valve, and the fourth connection line may be closed by the fifth valve.

The first expansion valve may allow the introduced refrigerant to flow in an expanded state, and the refrigerant discharged from the compressor may flow along the refrigerant line so as to sequentially pass through the first heat-exchanger, the second heat-exchanger, and the third heat-exchanger.

When an ambient air heat is to be recollected and a battery module is to be heated in a heating mode of a vehicle interior, a portion of the refrigerant line connecting the compressor and the first heat-exchanger may be opened by the first valve. A portion of the refrigerant line connecting a first end of the second connection line to a second end of the fourth connection line may be closed by the second valve. A portion of the refrigerant line connecting the second end of the first connection line to a first end of the fourth connection line may be closed by the first expansion valve. A portion of the refrigerant line connecting the second end of the fourth connection line to the first end of the first connection line may be opened. A portion of the first connection line may be opened by the second expansion valve so that a first end of the second connection line may be connected to the second heat-exchanger through the refrigerant line. The remaining portion of the first connection line may be closed by the third valve. The second connection line may be opened by the third expansion valve. The third connection line may be closed by the fourth valve, and the fourth connection line may be opened by the fifth valve.

The chiller may heat-exchange the supplied refrigerant with the coolant introduced from the battery module. The second expansion valve may allow the refrigerant introduced from the chiller through a portion of the first connection line to flow in an expanded state. The third expansion valve may allow the introduced refrigerant to flow without expansion. The refrigerant having passed through the first heat-exchanger from the compressor may be introduced into the chiller along the second connection line and a portion the first connection line. The refrigerant discharged from the chiller may be introduced into the second heat-exchanger along a portion of the refrigerant line in a state expanded in the second expansion valve. The refrigerant discharged from the second heat-exchanger may be supplied to the compressor along the fourth connection line and the opened portion of the refrigerant lines.

When an ambient air heat and the waste heat of an electrical component is to be recollected in a heating mode of a vehicle interior, a portion of the refrigerant line connecting the compressor and the first heat-exchanger may be opened by the first valve. A portion of the refrigerant line connecting a first end of the second connection line to a second end of the fourth connection line may be closed by the second valve. A portion of the refrigerant line connecting the first end of the first connection line to a first end of the fourth connection line may be closed by the first expansion valve. A portion of the refrigerant line connecting the second end of the fourth connection line to the first end of the first connection line may be opened. A portion of the first connection line may be opened by the second expansion valve so that a first end of the second connection line may be connected to the second heat-exchanger through the refrigerant line. The remaining portion of the first connection line may be closed by the third valve. The second connection line may be opened by the third expansion valve, the third connection line may be closed by the fourth valve, and the fourth connection line may be opened by the fifth valve.

The chiller may heat-exchange the supplied refrigerant with the coolant introduced from the electrical component. The second expansion valve may allow the refrigerant introduced from the chiller through a portion of the first connection line to flow without expansion. The third expansion valve may allow the introduced refrigerant to flow in an expanded state. The refrigerant having passed through the first heat-exchanger from the compressor may be introduced into the chiller along the second connection line and a portion the first connection line. The refrigerant discharged from the chiller may be introduced into the second heat-exchanger along the opened portion of the first connection line and a portion of the refrigerant line. The refrigerant discharged from the second heat-exchanger may be supplied to the compressor along the fourth connection line and the opened portion of the refrigerant lines.

When the waste heat of an electrical component is to be recollected in a heating-and-dehumidifying mode of a vehicle interior, a portion of the refrigerant line connecting the compressor and the first heat-exchanger may be opened by the first valve. A portion of the refrigerant line connecting a first end of the second connection line to a second end of the fourth connection line may be closed by the second valve. A portion of the refrigerant line connecting the first end of the first connection line to a first end of the fourth connection line may be opened by the first expansion valve. A portion of the refrigerant line connecting the second end of the fourth connection line to the first end of the first connection line is closed. A portion of the first connection line may be opened by the second expansion valve so that a first end of the second connection line may be connected to the first expansion valve through the refrigerant line. The remaining portion of the first connection line may be closed by the third valve, the second connection line may be opened by the third expansion valve, the third connection line may be closed by the fourth valve, and the fourth connection line may be closed by the fifth valve.

The first expansion valve may allow the introduced refrigerant to flow without expansion. The chiller may heat-exchange the supplied refrigerant with the coolant introduced from the electrical component. The second expansion valve may allow the refrigerant introduced from the chiller through a portion of the first connection line to flow without expansion. The third expansion valve may allow the introduced refrigerant to flow in an expanded state. The refrigerant having passed through the first heat-exchanger from the compressor may be introduced into the chiller along the second connection line and a portion the first connection line. The refrigerant discharged from the chiller may pass through the first expansion valve along the opened portion of the first connection line and a portion of the refrigerant line, to be introduced into the third heat-exchanger, and the refrigerant discharged from the third heat-exchanger may be supplied to the compressor along the opened portion of the refrigerant line.

The first valve, the second valve, the third valve, the fourth valve, and the fifth valve may be check valves configured to allow the refrigerant flowing in a corresponding line to flow in only one direction.

The first expansion valve, the second expansion valve, and the third expansion valve may be electronic expansion valves configured to selectively expand the refrigerant while controlling a flowing movement of the refrigerant.

The heat pump system may further include an accumulator provided on the refrigerant line between the third heat-exchanger and the compressor.

The second heat-exchanger and the chiller may be configured to cool or evaporate the interiorly introduced refrigerant.

The first heat-exchanger, the second heat-exchanger, and the third heat-exchanger may be air-cooled gas coolers configured to heat-exchange the interiorly introduced refrigerant with an air, and the chiller may be a water-cooled gas cooler configured to heat-exchange the interiorly introduced refrigerant with the coolant.

The refrigerant may be a R744 refrigerant formed of carbon dioxide.

The chiller may be respectively connected to an electrical component and a battery module through a first line and a second line through which the coolant circulates.

As described above, according to a heat pump system for a vehicle according to an embodiment of the present disclosure, cooling or heating of the vehicle interior may be performed by using a natural refrigerant, thereby enabling compliance with environmental regulations, and improving the overall marketability of the vehicle.

In addition, according to the present disclosure, by applying R744 refrigerant, which is a natural refrigerant utilizing carbon dioxide, the cooling and heating performance can be maximized by operating in a supercritical region in which the pressure and temperature of the refrigerant is higher than a critical pressure and temperature at the time of cooling and heating the vehicle interior.

In addition, according to the present disclosure, streamlining and simplification of the system may be achieved by efficiently adjusting the temperature of the battery module depending on the mode of the vehicle by using a single chiller where the coolant and the refrigerant are heat-exchanged with each other.

In addition, according to the present disclosure, by efficiently adjusting the temperature of the battery module, the optimal performance of the battery module may be obtained, and the overall travel distance of the vehicle may be increased through the efficient management of battery module.

In addition, according to the present disclosure, by heating the battery module by using the coolant heated through heat-exchange with the refrigerant, a separate coolant heater for heating the battery module may be removed, and the power consumption for increasing the temperature of the battery module can be minimized.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram of a heat pump system for a vehicle according to an embodiment of the present disclosure.

FIG. 2 is an operation diagram of a heat pump system for a vehicle according to an embodiment of the present disclosure, for cooling a battery module in a cooling mode of the vehicle interior.

FIG. 3 is an operation diagram according to a cooling-and-dehumidifying mode of the vehicle interior in a heat pump system for a vehicle according to an embodiment of the present disclosure.

FIG. 4 is an operation diagram of a heat pump system for a vehicle according to an embodiment of the present disclosure, for recollecting the ambient air heat and heating a battery module in a heating mode of the vehicle interior.

FIG. 5 is an operation diagram of a heat pump system for a vehicle according to an embodiment of the present disclosure, for recollecting the ambient air heat and the waste heat of an electrical component in a heating mode of the vehicle interior.

FIG. 6 is an operation diagram of a heat pump system for a vehicle according to an embodiment of the present disclosure, for recollecting the waste heat of the electrical component in a heating-and-dehumidifying mode of the vehicle interior.

### DETAILED DESCRIPTION OF THE DISCLOSURE

Embodiments of the present disclosure are hereinafter described in detail with reference to the accompanying drawings.

Embodiments of the present disclosure in the present specification and the constructions depicted in the drawings are only example embodiments of the present disclosure, and may not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise” and variations such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, data detector, or other such components may separately embody or be included with a processor and a memory, such as a non-transitory computer readable media, as part of the controller or component.

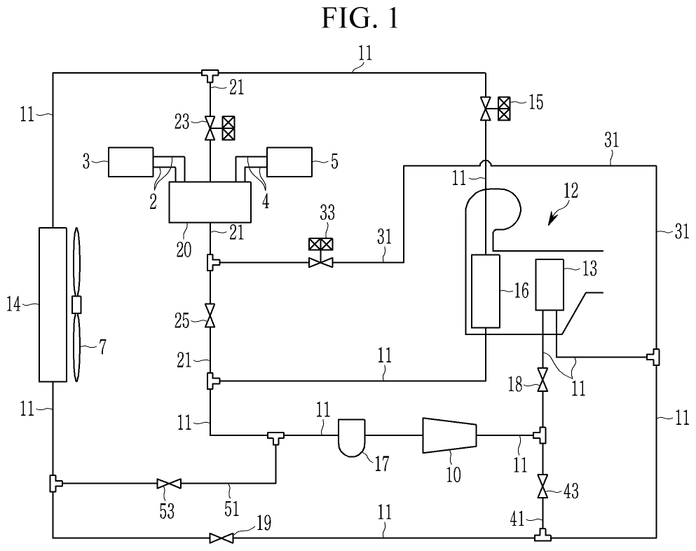

FIG. 1 is a block diagram of a heat pump system for a vehicle according to an embodiment of the present disclosure.

A heat pump system for a vehicle according to an embodiment of the present disclosure may perform cooling or heating of a vehicle interior by using a natural refrigerant in compliance with environmental regulations, and may efficiently adjust the temperature of a battery module 5 by using a single chiller 20 where the refrigerant and a coolant are heat-exchanged with each other.

The refrigerant may be an R744 refrigerant formed of carbon dioxide, which has an ozone depletion potential (ODP) of 0 and a global warming potential (GWP) of 1.

According to a heat pump system for a vehicle according to an embodiment of the present disclosure, by operating in the supercritical cycle, in which the pressure and temperature of the refrigerant is higher than a critical pressure and temperature, by applying the R744 refrigerant, which is a natural refrigerant utilizing carbon dioxide, the cooling and heating performance can be maximized.

A heat pump system according to an embodiment of the present disclosure may include a compressor 10, a first heat-exchanger 13, a second heat-exchanger 14, a first expansion valve 15, a third heat-exchanger 16, an accumulator 17, and the chiller 20, connected through the refrigerant line 11 to circulate the refrigerant through the refrigerant line 11.

The compressor 10 may compress the introduced refrigerant and allow the compressed refrigerant to flow through the refrigerant line 11 so that the refrigerant circulates along the refrigerant line 11.

The first heat-exchanger 13 may heat-exchange the refrigerant selectively supplied from the compressor 10 with the air.

The second heat-exchanger 14 may be connected to the first heat-exchanger 13 through the refrigerant line 11. Accordingly, the refrigerant supplied from the refrigerant line 11 may pass through the second heat-exchanger 14.

The second heat-exchanger 14 may be disposed at the front of the vehicle, and may cool or evaporate the refrigerant through heat-exchange with the air introduced from the outside while the vehicle is driving. A cooling fan 7 may be provided on a downstream side of the second heat-exchanger 14.

Since the R744 refrigerant is a supercritical refrigerant and does not have a phase change unlike the typical refrigerant, the term “gas cooling” may be used instead of the term “condensation”.

In an embodiment of the present disclosure, the first expansion valve 15 may be provided on the refrigerant line 11 between the second heat-exchanger 14 and the third heat-exchanger 16. The first expansion valve 15 may selectively expand the refrigerant introduced through the refrigerant line 11.

The first expansion valve 15 may selectively expand the refrigerant while controlling a flowing movement of the refrigerant.

In addition, the third heat-exchanger 16 may be provided on the refrigerant line 11 between the first expansion valve 15 and the compressor 10.

The first heat-exchanger 13 and the third heat-exchanger 16 may be provided inside a heating, ventilation, and air-conditioning (HVAC) module 12.

The first heat-exchanger 13, the second heat-exchanger 14, and the third heat-exchanger 16 may be an air-cooled gas cooler configured to heat-exchange the interiorly introduced refrigerant with the air.

The second heat-exchanger 14 may evaporate the refrigerant when the expanded refrigerant is introduced, and may cool the refrigerant when the unexpanded refrigerant is introduced.

In an embodiment of the present disclosure, the accumulator 17 may be provided on the refrigerant line 11 between the third heat-exchanger 16 and the compressor 10.

The accumulator 17 may supply only the gaseous refrigerant to the compressor 10, thereby improving the efficiency and durability of the compressor 10.

In an embodiment of the present disclosure, the chiller 20 may be connected to an electrical component 3 through a first line 2 through which the coolant circulates.

The electrical component 3 may include a power conversion device such as an electrical power control unit (EPCU), a motor, an inverter, or an on-board charger (OBC), and an autonomous driving controller, or the like.

The electrical component 3 configured as such may be connected to the first line 2 to be cooled in a water-cooled manner.

The chiller 20 may adjust the temperature of the electrical component 3 by using the coolant heat-exchanged with the refrigerant, and may recollect a waste heat of the electrical component 3.

In addition, the chiller 20 may be connected to the battery module 5 through a second line 4 through which the coolant circulates. Accordingly, the coolant may selectively circulate through the chiller 20.

The chiller 20 may adjust a temperature of the coolant by heat-exchanging the supplied refrigerant with the coolant. The chiller 20 may be a water-cooled gas cooler configured to heat-exchange the interiorly introduced refrigerant with the coolant.

The chiller 20 may be connected to the refrigerant line 11 through a first connection line 21.

A first end of the first connection line 21 may be connected to the refrigerant line 11 connecting the second heat-exchanger 14 and the first expansion valve 15. In addition, a second end of the first connection line 21 may be connected to the refrigerant line 11 connecting the third heat-exchanger 16 and the compressor 10.

The second end of the first connection line 21 may be connected to the refrigerant line 11 between the third heat-exchanger 16 and the accumulator 17.

The chiller 20 may adjust the temperature of the coolant by heat-exchanging the coolant selectively introduced through the first line 2 or the second line 4 with the refrigerant selectively supplied through the first connection line 21.

Accordingly, the coolant heat-exchanged in the chiller 20 may circulate the electrical component 3 through the first line 2. In addition, the coolant heat-exchanged in the chiller 20 may circulate the battery module 5 through the second line 4.

A water pump (not shown) may be provided on the first line 2 and the second line 4.

The coolant may circulate along the first line 2 and the second line 4 according to an operation of each water pump (not shown).

Accordingly, the coolant heat-exchanged with the refrigerant in the chiller 20 may adjust the electrical component 3 and the temperature of the battery module 5, while being selectively supplied to the electrical component 3 and the battery module 5.

The heat pump system may further include a first valve 18, a second valve 19, a second expansion valve 23, a third valve 25, a second connection line 31, a third expansion valve 33, a third connection line 41, a fourth valve 43, a fourth connection line 51, and a fifth valve 53.

The first valve 18 may be provided on the refrigerant line 11 between the compressor 10 and the first heat-exchanger 13.

The first valve 18 may selectively open and close the refrigerant line 11 so that the refrigerant discharged from the compressor 10 is introduced into the first heat-exchanger 13.

The first valve 18 may prevent the refrigerant from flowing back from the first heat-exchanger 13 toward the compressor 10. The first valve 18 may be a check valve that allows the refrigerant to flow in one direction along the refrigerant line 11.

In a cooling mode of the vehicle interior, the first valve 18 configured as such may close a portion of the refrigerant line 11 connecting the compressor 10 and the first heat-exchanger 13 so that the refrigerant discharged from the compressor 10 is not introduced into the first heat-exchanger 13.

When dehumidification is required in the cooling mode of the vehicle interior, the first valve 18 may open the portion of the refrigerant line 11 connecting the compressor 10 and the first heat-exchanger 13 so that the refrigerant discharged from the compressor 10 is introduced into the first heat-exchanger 13.

In a heating mode of the vehicle interior, the first valve 18 may open the portion of the refrigerant line 11 connecting the compressor 10 and the first heat-exchanger 13 so that the refrigerant discharged from the compressor 10 is introduced into the first heat-exchanger 13.

The second valve 19 may be provided on the refrigerant line 11 between the first heat-exchanger 13 and the second heat-exchanger 14.

The second valve 19 may selectively open and close the refrigerant line 11 so that the refrigerant discharged from the first heat-exchanger 13 is selectively introduced into the second heat-exchanger 14.

The second valve 19 may prevent the refrigerant from flowing back from the second heat-exchanger 14 toward the first heat-exchanger 13. The second valve 19 may be a check valve that allows the refrigerant to flow in only one direction along the refrigerant line 11.

In an embodiment of the present disclosure, the second expansion valve 23 may be provided on the first connection line 21 between the first end of the first connection line 21 and the chiller 20.

The second expansion valve 23 may selectively expand the refrigerant introduced into the first connection line 21 and allow the selectively expanded refrigerant to flow into the chiller 20, depending on the selected air conditioning mode of the vehicle interior.

In addition, the second expansion valve 23 may supply the refrigerant introduced into the first connection line 21 to the chiller 20 without expansion, or may close the first connection line 21 so that the refrigerant is not supplied to the chiller 20.

The second expansion valve 23 configured as such may selectively expand the refrigerant while controlling the flowing movement of the refrigerant.

In more detail, when cooling the battery module 5 by using the coolant heat-exchanged with the refrigerant in the chiller 20, the second expansion valve 23 may open the first connection line 21. At the same time, the second expansion valve 23 may expand the refrigerant introduced into the first connection line 21 and allow the expanded refrigerant to flow into the chiller 20.

The second expansion valve 23 may expand the refrigerant discharged from the second heat-exchanger 14 to lower its temperature and allow the expanded refrigerant to flow into the chiller 20, and thereby may further lower temperature of the coolant passing through the interior of the chiller 20.

Accordingly, the coolant having its temperature decreased while passing through the chiller 20 may be introduced into the battery module 5, thereby achieving more efficient cooling.

In the selected air conditioning mode of the vehicle interior, the second expansion valve 23 may selectively expand the refrigerant supplied from the chiller 20 through the first connection line 21 and allow the refrigerant to flow through the refrigerant line 11 connected to the first end of the first connection line 21.

When heating the battery module 5 in the heating mode of the vehicle interior, the second expansion valve 23 may expand the refrigerant introduced from the chiller 20, and may allow the expanded refrigerant to flow along the refrigerant line 11 connected to the second heat-exchanger 14.

In an embodiment of the present disclosure, the third valve 25 may be provided on the first connection line 21 between the second end of the first connection line 21 and the chiller 20.

The third valve 25 may selectively open a portion of the first connection line 21 so that the refrigerant discharged from the chiller 20 is introduced into the accumulator 17.

The third valve 25 may prevent the refrigerant from flowing back from the second end of the first connection line 21 toward the chiller 20. The third valve 25 may be a check valve that allows the refrigerant to flow in only one direction along the first connection line 21.

When the battery module 5 is to be cooled in the cooling mode of the vehicle interior, the third valve 25 configured as such may open a portion of the first connection line 21 so that the refrigerant having passed through the chiller 20 is introduced into the accumulator 17.

In the heating mode of the vehicle interior, the third valve 25 may close a portion of the first connection line 21 so that the refrigerant is not introduced from the second end of the first connection line 21 to the chiller 20.

In an embodiment of the present disclosure, a first end of the second connection line 31 may be connected to the refrigerant line 11 between the first heat-exchanger 13 and the second heat-exchanger 14. A second end of the second connection line 31 may be connected to the first connection line 21 between the second end of the first connection line 21 and the chiller 20.

The third expansion valve 33 may be provided on the second connection line 31. The third expansion valve 33 may selectively open and close the second connection line 31, and may selectively expand the refrigerant introduced through the second connection line 31.

In the cooling mode of the vehicle interior, the third expansion valve 33 may close the second connection line 31. On the other hand, in the heating mode of the vehicle interior, the third expansion valve 33 may open the second connection line 31.

In addition, in the heating mode and heating-and-dehumidifying mode of the vehicle interior, the third expansion valve 33 may open the second connection line 31, and may expand the refrigerant introduced through the second connection line 31.

In addition, when heating of the battery module 5 is required in the heating mode of the vehicle interior, the third expansion valve 33 may open the second connection line 31, and may allow the refrigerant introduced through the second connection line 31 to flow without expansion.

The third expansion valve 33 may selectively expand the refrigerant while controlling the flowing movement of the refrigerant.

In an embodiment of the present disclosure, a first end of the third connection line 41 may be connected to the refrigerant line 11 between the compressor 10 and the first heat-exchanger 13. The first end of the third connection line 41 may be connected to the refrigerant line 11 between the compressor 10 and the first valve 18.

A second end of the third connection line 41 may be connected to the refrigerant line 11 between the first heat-exchanger 13 and the second heat-exchanger 14. The second end of the third connection line 41 may be connected to the refrigerant line 11 between the first heat-exchanger 13 and the second valve 19.

The fourth valve 43 may be provided on the third connection line 41. The fourth valve 43 may selectively open and close the third connection line 41.

The fourth valve 43 may prevent the refrigerant flowing from the first heat-exchanger 13 toward the second heat-exchanger 14 from flowing back toward the compressor 10 through the third connection line 41.

The fourth valve 43 may be a check valve that allows the refrigerant to flow in only one direction along the third connection line 41.

In the cooling mode of the vehicle interior, the fourth valve 43 may open the third connection line 41.

In the cooling-and-dehumidifying mode, or the heating mode, or the heating-and-dehumidifying mode, of the vehicle interior, the fourth valve 43 may close the third connection line 41.

In an embodiment of the present disclosure, a first end of the fourth connection line 51 may be connected to the refrigerant line 11 between the third heat-exchanger 16 and the compressor 10. The first end of the fourth connection line 51 may be connected to the refrigerant line 11 between the third heat-exchanger 16 and the accumulator 17.

A second end of the fourth connection line 51 may be connected to the refrigerant line 11 between the second valve 19 and the second heat-exchanger 14.

In addition, the fifth valve 53 may be provided on the fourth connection line 51. The fifth valve 53 may selectively open and close the fourth connection line 51, to control the flowing movement of the refrigerant.

The fifth valve 53 may prevent the refrigerant flowing from the third heat-exchanger 16 or the chiller 20 toward the accumulator 17 from flowing back to the second heat-exchanger 14 through the fourth connection line 51.

The fifth valve 53 may be a check valve that allows the refrigerant to flow in only one direction along the fourth connection line 51.

In the cooling mode, or in the cooling-and-dehumidifying mode, or in the heating-and-dehumidifying mode, of the vehicle interior, the fifth valve 53 configured as such may close the fourth connection line 51.

When the battery module is to be heated in the heating mode of the vehicle interior, or in the heating mode of the vehicle interior, the fifth valve 53 may open the fourth connection line 51.

The first valve 18, the second valve 19, the third valve 25, the fourth valve 43, and the fifth valve 53 may be 2-way check valves opening and closing the refrigerant line 11, the first connection line 21, the third connection line 41, and the fourth connection line 51, and controlling the reverse flow of the refrigerant, and the flow rate of the refrigerant.

In addition, the first expansion valve 15, the second expansion valve 23, and the third expansion valve 33 may be electronic expansion valves configured to selectively expand the refrigerant while controlling the flowing movement of the refrigerant.

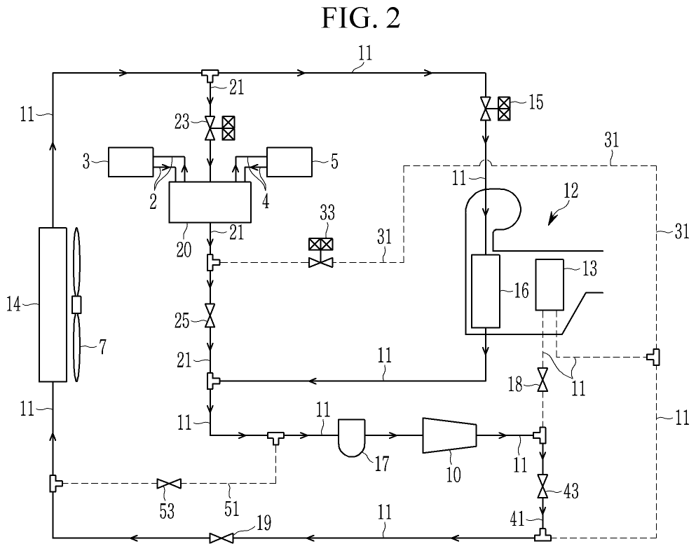

Hereinafter, an operation and action of a heat pump system for a vehicle according to an embodiment of the present disclosure configured as described above are described in detail with reference to FIG. 2-5 .

An operation for cooling the battery module 5 in the cooling mode of the vehicle interior is described in detail below with reference to FIG. 2.

FIG. 2 is an operation diagram of a heat pump system for a vehicle according to an embodiment of the present disclosure, for cooling a battery module in the cooling mode of the vehicle interior.

Referring to FIG. 2, the coolant may circulate along the first line 2 by an operation of a water pump (not shown). At the same time, the coolant may circulate along the second line 4 by the operation of a water pump (not shown).

The coolant having passed through the electrical component 3 may be supplied to the chiller 20 along the first line 2, and the coolant having passed through the battery module 5 may be supplied to the chiller 20 along the second line 4.

In the heat pump system, respective components may operate in order to cool the vehicle interior. Accordingly, the refrigerant may circulate along the refrigerant line 11.

The portion of the refrigerant line 11 connecting the compressor 10 and the first heat-exchanger 13, and the portion of the refrigerant line 11 connecting the first heat-exchanger 13 and the second end of the third connection line 41 may be closed by the first valve 18.

The remaining portion of the refrigerant line 11 connecting the second end of the third connection line 41 to the second heat-exchanger 14, the third heat-exchanger 16, and the compressor 10 may be opened by the second valve 19 and the first expansion valve 15.

The first expansion valve 15 may allow the introduced refrigerant to flow in an expanded state.

The first connection line 21 may be opened by the second expansion valve 23 and the third valve 25 in order to cool the electrical component 3 and the battery module 5.

Accordingly, the coolant having passed through the battery module 5 may be supplied to the chiller 20 along the second line 4.

The second expansion valve 23 may expand the refrigerant introduced through the first connection line 21 and allow the expanded refrigerant to flow into the chiller 20 so that the battery module 5 may be cooled by using the coolant heat-exchanged with the refrigerant in the chiller 20.

Accordingly, the coolant having passed through the chiller 20 may be cooled through heat-exchange with the expanded refrigerant supplied to the chiller 20.

The coolant passing through the chiller 20 may be cooled through heat-exchange with the expanded refrigerant supplied to the chiller 20. The coolant cooled in the chiller 20 may be supplied to the battery module 5 along the second line 4. Accordingly, the battery module 5 may be efficiently cooled by the coolant cooled in the chiller 20.

The second connection line 31 may be closed by the third expansion valve 33. The third connection line 41 may be opened by the fourth valve 43.

In addition, the fourth connection line 51 may be closed by the fifth valve 53.

In such a state, the refrigerant discharged from the compressor 10 may flow along the third connection line 41 without passing through the first heat-exchanger 13.

The refrigerant discharged from the compressor 10 may flow along the third connection line 41, and may be introduced into the second heat-exchanger 14 along the portion of the refrigerant line 11 connected to the second heat-exchanger 14.

The second heat-exchanger 14 may primarily cool the refrigerant by using the air introduced from the outside.

A partial refrigerant among the refrigerant discharged from the second heat-exchanger 14 may be introduced into the chiller 20 along the first connection line 21.

The refrigerant introduced into the chiller 20 may be heat-exchanged with respective coolants supplied through the first line 2 and may be introduced into the compressor 10 after passing through the accumulator 17 through the second line 4, and the refrigerant line 11 connected to the first connection line 21.

In addition, a remaining refrigerant among the refrigerant discharged from the second heat-exchanger 14 may be introduced into the first expansion valve 15 along the refrigerant line 11 to cool the vehicle interior.

The first expansion valve 15 may expand the introduced through the refrigerant line 11 and allow the expanded refrigerant to flow into the third heat-exchanger 16.

The refrigerant having passed through the third heat-exchanger 16 may sequentially pass through the accumulator 17 the compressor 10 along the refrigerant line 11.

The refrigerant discharged from the chiller 20, and the refrigerant discharged from the third heat-exchanger 16 may be supplied to the compressor 10 after passing through the accumulator 17 along the refrigerant line 11.

The air introduced into the HVAC module 12 may be cooled by the low-temperature refrigerant introduced into the third heat-exchanger 16 while passing through the third heat-exchanger 16.

The cooled air may pass through the first heat-exchanger 13 that is not supplied with the refrigerant to be directly introduced into the vehicle interior, thereby cooling the vehicle interior.

While repeatedly performing the above-described processes, in the cooling mode of the vehicle interior, the refrigerant may cool the vehicle interior and at the same time, cool the coolant through heat-exchange while passing through the chiller 20.

In addition, a low-temperature coolant cooled in the chiller 20 may be introduced into the battery module 5 through the second line 4. Accordingly, the battery module 5 may be efficiently cooled by the supplied low-temperature coolant.

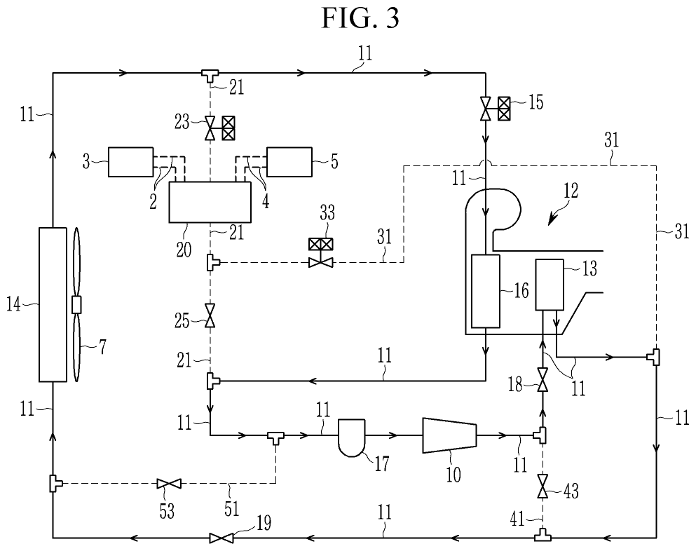

In an embodiment of the present disclosure, an operation in the cooling-and-dehumidifying mode of the vehicle interior is described in detail below with reference to FIG. 3.

FIG. 3 is an operation diagram according to the cooling-and-dehumidifying mode of the vehicle interior in a heat pump system for a vehicle according to an embodiment of the present disclosure.

Referring to FIG. 3, the coolant does not circulate through the first line 2 and the second line 4.

In the heat pump system, respective components may operate in order to cool the vehicle interior. Accordingly, the refrigerant may circulate along the refrigerant line 11.

The refrigerant line 11 connecting the compressor 10, the first heat-exchanger 13, the second heat-exchanger 14, the first expansion valve 15, and the third heat-exchanger 16 may be opened by the first valve 18, the second valve 19, and the first expansion valve 15.

The first connection line 21 may be closed by the second expansion valve 23 and the third valve 25. The second connection line 31 may be closed by the third expansion valve 33.

The third connection line 41 may be closed by the fourth valve 43. In addition, the fourth connection line 51 may be closed by the fifth valve 53.

In such a state, the refrigerant discharged from the compressor 10 may sequentially pass through the first heat-exchanger 13 and the second heat-exchanger 14 along the refrigerant line 11.

The first heat-exchanger 13 may cool the refrigerant by using the air introduced into the HVAC module 12.

The refrigerant discharged from the first heat-exchanger 13 may be introduced into the second heat-exchanger 14 along the refrigerant line 11. The second heat-exchanger 14 may additionally cool the refrigerant by using the air introduced from the outside.

In addition, the refrigerant discharged from the second heat-exchanger 14 may be introduced into the first expansion valve 15 along the refrigerant line 11 to cool the vehicle interior.

The first expansion valve 15 may expand the introduced refrigerant through the refrigerant line 11 and allow the expanded refrigerant to flow into the third heat-exchanger 16.

The refrigerant having an increased cooling level while sequentially passing through the first heat-exchanger 13 the second heat-exchanger 14 may be expanded and supplied to the third heat-exchanger 16.

In an embodiment of the present disclosure, the first heat-exchanger 13 and the second heat-exchanger 14 may respectively cool the refrigerant through heat-exchange with the air.

By such an operation, the heat pump system may more efficiently cool the R744 refrigerant formed of carbon dioxide, thereby securing a larger phase change heat transfer section of the refrigerant.

In addition, as the refrigerant having secured the larger phase change heat transfer section is evaporated in the third heat-exchanger 16, the temperature of the air passing through the third heat-exchanger 16 may be further lowered, thereby improving the cooling performance and efficiency.

The refrigerant having passed through the third heat-exchanger 16 may sequentially pass through the accumulator 17 the compressor 10 along the refrigerant line 11.

The air introduced into the HVAC module 12 may be cooled by the low-temperature refrigerant introduced into the third heat-exchanger 16 while passing through the third heat-exchanger 16.

The cooled air may be introduced into the vehicle interior in a state dehumidified while passing through the first heat-exchanger 13, thereby smoothly cooling and dehumidifying the vehicle interior.

While repeatedly performing the above-described processes, in the cooling-and-dehumidifying mode of the vehicle interior, the refrigerant may cool and dehumidify the vehicle interior.

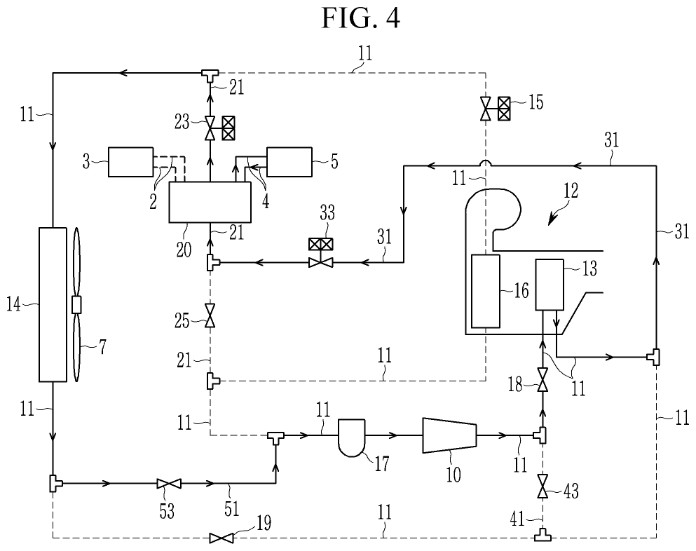

In an embodiment of the present disclosure, an operation of recollecting an ambient air heat in the heating mode of the vehicle interior, and heating the battery module 5 is described in detail below with reference to FIG. 4.

FIG. 4 is an operation diagram of a heat pump system for a vehicle according to an embodiment of the present disclosure, for recollecting the ambient air heat and heating the battery module in the heating mode of the vehicle interior.

Referring to FIG. 4, in the heating mode of the vehicle interior, the heat pump system may recollect the ambient air heat, and the temperature of the battery module 5 may be increased by using the coolant heat-exchanged with the refrigerant.

The coolant does not circulate through the first line 2. At the same time, the coolant may circulate along the second line 4 by the operation of a water pump (not shown).

Accordingly, the coolant having passed through the battery module 5 may be supplied to the chiller 20 along the second line 4.

In the heat pump system, respective components may operate in order to heat the vehicle interior. Accordingly, the refrigerant may circulate along the refrigerant line 11.

The portion of the refrigerant line 11 connecting the compressor 10 and the first heat-exchanger 13 may be opened by the first valve 18.

The portion of the refrigerant line 11 connecting the first end of the second connection line 31 to the second end of the fourth connection line 51 may be closed by the second valve 19.

In addition, the portion of the refrigerant line 11 connecting the first end of the first connection line 21 to the first end of the fourth connection line 51 may be closed by the first expansion valve 15.

In addition, the portion of the refrigerant line 11 connecting the second end of the fourth connection line 51 to the first end of the first connection line 21 may be opened.

A portion of the first connection line 21 may be opened by the second expansion valve 23 so that the first end of the second connection line 31 is connected to the second heat-exchanger 14 through the refrigerant line 11. The remaining portion of the first connection line 21 may be closed by the third valve 25.

The second expansion valve 23 may allow the refrigerant introduced from the chiller 20 to flow through the opened portion of the first connection line 21 to flow in an expanded state.

The second connection line 31 may be opened by the third expansion valve 33. The third expansion valve 33 may allow the introduced refrigerant to flow without expansion.

In an embodiment of the present disclosure, the third connection line 41 may be closed by the fourth valve 43. In addition, the fourth connection line 51 may be opened by the fifth valve 53.

Accordingly, the refrigerant discharged from the compressor 10 may be introduced into the first heat-exchanger 13 along the refrigerant line 11. The refrigerant supplied to the first heat-exchanger 13 may increase the temperature of the air introduced into the HVAC module 12.

The air introduced into the HVAC module 12 from the outside may be converted into a high-temperature state while passing through the first heat-exchanger 13 and then introduced into the vehicle interior, thereby implementing heating of the vehicle interior.

In addition, the refrigerant having passed through the first heat-exchanger 13 may be introduced into the third expansion valve 33 along the second connection line 31.

The third expansion valve 33 may allow the refrigerant introduced through the second connection line 31 to flow to the opened portion of the first connection line 21 without expansion.

The refrigerant from the compressor 10 having passed through the first heat-exchanger 13 may be introduced into the chiller 20 along the second connection line 31 and a portion the first connection line 21.

The refrigerant introduced into the chiller 20 may increase the temperature of the coolant while heat-exchanging with the coolant supplied from the battery module 5 through the second line 4.

The coolant heated in the chiller 20 may be supplied to the battery module 5 along the second line 4. Accordingly, the temperature of the battery module 5 may be efficiently increased by the coolant heated in the chiller 20.

The refrigerant discharged from the chiller 20 may be introduced into the second expansion valve 23 along the first connection line 21. The second expansion valve 23 may expand the refrigerant so that the expanded refrigerant is supplied to the second heat-exchanger 14.

Accordingly, the refrigerant discharged from the chiller 20 may be introduced into the second heat-exchanger 14 along the portion of the refrigerant line 11 while being expanded in the second expansion valve 23.

The second heat-exchanger 14 may recollect the ambient air heat while evaporating the expanded refrigerant through heat-exchange with the externally introduced air.

Since the heat pump system uses the recollected ambient air heat to increase the temperature of the refrigerant, the power consumption of the compressor 10 may be decreased, and the heating efficiency may be improved.

The refrigerant discharged from the second heat-exchanger 14 may be supplied to the compressor 10 after passing through the accumulator 17 along the fourth connection line 51 and the opened portion of the refrigerant lines 11.

In addition, the refrigerant compressed to the high-temperature and high-pressure state in the compressor 10 may be supplied back to the first heat-exchanger 13, thereby repeatedly performing above-described processes.

The refrigerant supplied to the first heat-exchanger 13 may increase the temperature of the air introduced into the HVAC module 12.

Accordingly, the air introduced into the HVAC module 12 may be converted into a high-temperature state while passing through the first heat-exchanger 13 and introduced into the vehicle interior, thereby implementing heating of the vehicle interior.

The coolant heated through heat-exchange with the refrigerant in the chiller 20 may be supplied to the battery module 5 along the second line 4. Accordingly, the battery module 5 may be rapidly heated by the coolant heated in the chiller 20.

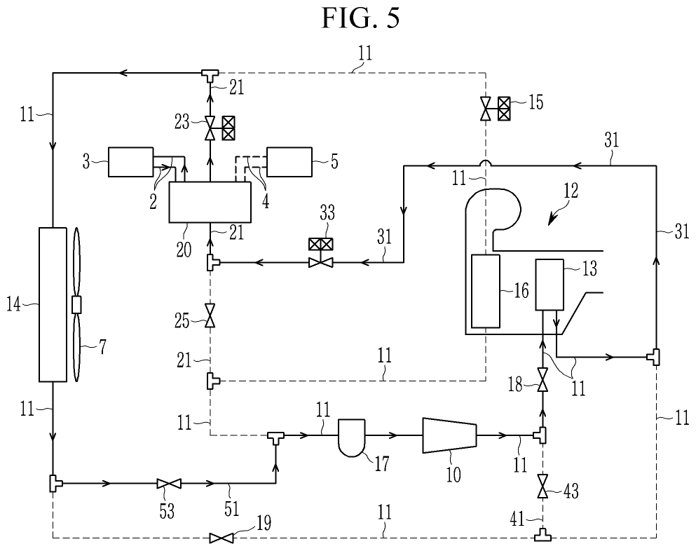

In an embodiment of the present disclosure, an operation for recollecting the ambient air heat and the waste heat of the electrical component 3 in the heating mode of the vehicle interior is described in detail below with reference to FIG. 5.

FIG. 5 is an operation diagram of a heat pump system for a vehicle according to an embodiment of the present disclosure, for recollecting the ambient air heat and the waste heat of the electrical component in the heating mode of the vehicle interior.

Referring to FIG. 5, the coolant may circulate along the first line 2 by the operation of a water pump (not shown). The coolant may not flow through the second line 4. The second line 4 may be closed.

Accordingly, the coolant having passed through the electrical component 3 may be supplied to the chiller 20 along the first line 2.

In the heat pump system, respective components may operate in order to heat the vehicle interior. Accordingly, the refrigerant may circulate along the refrigerant line 11.

The portion of the refrigerant line 11 connecting the compressor 10 and the first heat-exchanger 13 may be opened by the first valve 18.

The portion of the refrigerant line 11 connecting the first end of the second connection line 31 to the second end of the fourth connection line 51 may be closed by the second valve 19.

In addition, the portion of the refrigerant line 11 connecting the first end of the first connection line 21 to the first end of the fourth connection line 51 may be closed by the first expansion valve 15.

In addition, the portion of the refrigerant line 11 connecting the second end of the fourth connection line 51 to the first end of the first connection line 21 may be opened.

A portion of the first connection line 21 may be opened by the second expansion valve 23 so that the first end of the second connection line 31 is connected to the second heat-exchanger 14 through the refrigerant line 11. The remaining portion of the first connection line 21 may be closed by the third valve 25.

The second expansion valve 23 may allow the refrigerant introduced from the chiller 20 through the opened portion of the first connection line 21 to flow without expansion.

The second connection line 31 may be opened by the third expansion valve 33. The third expansion valve 33 may allow the introduced refrigerant to flow in an expanded state.

In an embodiment of the present disclosure, the third connection line 41 may be closed by the fourth valve 43. In addition, the fourth connection line 51 may be opened by the fifth valve 53.

Accordingly, the refrigerant discharged from the compressor 10 may be introduced into the first heat-exchanger 13 along the refrigerant line 11. The refrigerant supplied to the first heat-exchanger 13 may increase the temperature of the air introduced into the HVAC module 12.

The air introduced into the HVAC module 12 from the outside may be converted into a high-temperature state while passing through the first heat-exchanger 13 and then introduced into the vehicle interior, thereby implementing heating of the vehicle interior.

In addition, the refrigerant having passed through the first heat-exchanger 13 may be introduced into the third expansion valve 33 along the second connection line 31.

The third expansion valve 33 may allow the refrigerant introduced through the second connection line 31 to flow to the opened portion of the first connection line 21 in an expanded state.

The refrigerant from the compressor 10 having passed through the first heat-exchanger 13 may be introduced into the chiller 20 along the second connection line 31 and a portion the first connection line 21.

The chiller 20 may evaporate the expanded refrigerant through heat-exchange with the coolant supplied through the first line 2. The chiller 20 may recollect the waste heat of the electrical component 3 from the coolant heated by recollecting the waste heat from the electrical component 3.

The refrigerant discharged from the chiller 20 may be introduced into the second expansion valve 23 along the first connection line 21. The second expansion valve 23 may allow the refrigerant to flow without expansion.

Accordingly, the refrigerant discharged from the chiller 20 may be introduced into the second heat-exchanger 14 along the portion of the refrigerant line 11 while being in unexpanded in the second expansion valve 23.

The second heat-exchanger 14 may recollect the ambient air heat while evaporating the introduced refrigerant through heat-exchange with the externally introduced air.

By using the recollected waste heat of the electrical component 3 and ambient air heat to increase the temperature of the refrigerant, the heat pump system may decrease the power consumption of the compressor 10, and may improve the heating efficiency.

The refrigerant discharged from the second heat-exchanger 14 may be supplied to the compressor 10 after passing through the accumulator 17 along the fourth connection line 51 and the opened portion of the refrigerant lines 11.

In addition, the refrigerant compressed to the high-temperature and high-pressure state in the compressor 10 may be supplied back to the first heat-exchanger 13, thereby repeatedly performing above-described processes.

The refrigerant supplied to the first heat-exchanger 13 may increase the temperature of the air introduced into the HVAC module 12.

Accordingly, the air introduced into the HVAC module 12 may be converted into a high-temperature state while passing through the first heat-exchanger 13 and introduced into the vehicle interior, thereby implementing heating of the vehicle interior.

Although not shown in the drawings, when the waste heat of the battery module 5 is to be recollected together, the coolant may circulate along the second line 4 by the operation of a water pump (not shown). Accordingly, the coolant having passed through the battery module 5 may be supplied to the chiller 20 along the second line 4.

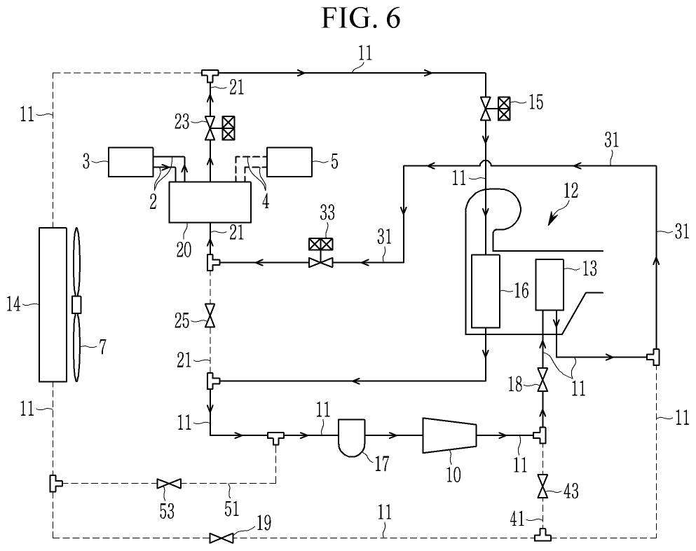

In an embodiment of the present disclosure, an operation of recollecting the waste heat of the electrical component 3 in a heating-and-dehumidifying mode of the vehicle interior is described in detail below with reference to FIG. 6.

FIG. 6 is an operation diagram of a heat pump system for a vehicle according to an embodiment of the present disclosure, for recollecting the waste heat of the electrical component in the heating-and-dehumidifying mode of the vehicle interior.

Referring to FIG. 6, the coolant may circulate along the first line 2 by the operation of a water pump (not shown). The coolant may not flow through the second line 4. The second line 4 may be closed.

Accordingly, the coolant having passed through the electrical component 3 may be supplied to the chiller 20 along the first line 2.

In the heat pump system, respective components may operate in order to heat and dehumidify the vehicle interior. Accordingly, the refrigerant may circulate along the refrigerant line 11.

The portion of the refrigerant line 11 connecting the compressor 10 and the first heat-exchanger 13 may be opened by the first valve 18.

The portion of the refrigerant line 11 connecting the first end of the second connection line 31 to the second end of the fourth connection line 51 may be closed by the second valve 19.

In addition, the portion of the refrigerant line 11 connecting the first end of the first connection line 21 to the first end of the fourth connection line 51 may be opened by the first expansion valve 15.

The first expansion valve 15 may allow the introduced refrigerant to flow without expansion.

In addition, the portion of the refrigerant line 11 connecting the second end of the fourth connection line 51 to the first end of the first connection line 21 may be closed.

A portion of the first connection line 21 may be opened by the second expansion valve 23 so that the first end of the second connection line 31 is connected to the first expansion valve 15 through the refrigerant line 11. The remaining portion of the first connection line 21 may be closed by the third valve 25.

The second expansion valve 23 may allow the refrigerant introduced from the chiller 20 through the opened portion of the first connection line 21 to flow without expansion.

The second connection line 31 may be opened by the third expansion valve 33. The third expansion valve 33 may allow the introduced refrigerant to flow in an expanded state.

In an embodiment of the present disclosure, the third connection line 41 may be closed by the fourth valve 43. In addition, the fourth connection line 51 may be closed by the fifth valve 53.

Accordingly, the refrigerant discharged from the compressor 10 may be introduced into the first heat-exchanger 13 along the refrigerant line 11. The first heat-exchanger 13 may cool the introduced refrigerant by using the air introduced into the HVAC module 12.

The refrigerant supplied to the first heat-exchanger 13 may increase the temperature of the air introduced into the HVAC module 12.

The air introduced into the HVAC module 12 from the outside may be converted into a high-temperature state while passing through the first heat-exchanger 13 and then introduced into the vehicle interior, thereby implementing heating of the vehicle interior.

In addition, the refrigerant having passed through the first heat-exchanger 13 may be introduced into the third expansion valve 33 along the second connection line 31.

The third expansion valve 33 may allow the refrigerant introduced through the second connection line 31 to flow to the opened portion of the first connection line 21 in an expanded state.

The refrigerant from the compressor 10 having passed through the first heat-exchanger 13 may be introduced into the chiller 20 along the second connection line 31 and a portion the first connection line 21.

The chiller 20 may evaporate the expanded refrigerant through heat-exchange with the coolant supplied through the first line 2. The chiller 20 may recollect the waste heat of the electrical component 3 from the coolant heated by recollecting the waste heat from the electrical component 3.

The refrigerant discharged from the chiller 20 may be introduced into the second expansion valve 23 along the first connection line 21. The second expansion valve 23 may allow the refrigerant to flow without expansion.

Accordingly, the refrigerant discharged from the chiller 20 may be introduced into the first expansion valve 15 along the portion of the refrigerant line 11 while being in unexpanded in the second expansion valve 23.

Since the heat pump system uses the recollected waste heat of the electrical component 3 to increase the temperature of the refrigerant, the power consumption of the compressor 10 may be decreased, and the heating efficiency may be improved.

The refrigerant discharged from the first expansion valve 15 may be introduced into the third heat-exchanger 16 along the opened refrigerant line 11.

The refrigerant discharged from the chiller 20 may pass through the first expansion valve 15 along the opened portion of the first connection line 21 and the portion of the refrigerant line 11, to be introduced into the third heat-exchanger 16.

The refrigerant having passed through the third heat-exchanger 16 may pass through the accumulator 17 along the opened portion of the refrigerant line 11. In addition, the refrigerant having passed through the accumulator 17 may be supplied to the compressor 10.

Then, the refrigerant compressed into the high-temperature and high-pressure state by the compressor 10 may be again supplied to the first heat-exchanger 13 along the refrigerant line 11, thereby repeatedly performing the above-described processes.

As described above, the refrigerant supplied to the first heat-exchanger 13 may increase the temperature of the air introduced into the HVAC module 12.

The air introduced into the HVAC module 12 may be dehumidified by the low-temperature refrigerant introduced into the third heat-exchanger 16 while passing through the third heat-exchanger 16. Thereafter, it is converted into a high-temperature state while passing through the first heat-exchanger 13 and introduced into the vehicle interior, thereby smoothly heating and dehumidifying the vehicle interior.

Therefore, as described above, when a heat pump system for a vehicle according to an embodiment of the present disclosure is applied, cooling or heating of the vehicle interior may be performed by using a natural refrigerant, thereby enabling compliance with environmental regulations, and improving the overall marketability of the vehicle.

In addition, according to the present disclosure, by operating in a supercritical region in which the pressure and temperature of the refrigerant is higher than the critical pressure and temperature at the time of cooling and heating the vehicle interior, by applying the R744 refrigerant, which is a natural refrigerant utilizing carbon dioxide, the cooling and heating performance can be maximized.

In addition, according to the present disclosure, by efficiently adjusting the temperature of the battery module 5 depending on the mode of the vehicle by using the single chiller 20 where the coolant and the refrigerant are heat-exchanged with each other, streamlining and simplification of the system may be achieved.

In addition, according to the present disclosure, by efficiently adjusting the temperature of the battery module 5, the optimal performance of the battery module 5 may be obtained, and the overall travel distance of the vehicle may be increased through the efficient management of the battery module 5.

In addition, according to the present disclosure, by heating the battery module 5 by using the coolant heated increased through heat-exchange with the refrigerant, a separate coolant heater for heating of the battery module 5 may be removed, and the power consumption for increasing the temperature of the battery module 5 can be minimized.

In addition, according to the present disclosure, through streamlining of an entire system, it is possible to reduce manufacturing cost and weight and improve space utilization.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2, 4: first and second lines
3: electrical component
5: battery module
7: cooling fan
10: compressor
11: refrigerant line
12: HVAC module
13, 14, 16: first, second, and third heat-exchangers
15: first expansion valve
17: accumulator
18, 19: first and second valves
20: chiller
21: first connection line
23: second expansion valve
25: third valve
31: second connection line
33: third expansion valve
41: third connection line
43: fourth valve
51: fourth connection line
53: fifth valve

What is claimed is:

1. A heat pump system for a vehicle, the heat pump system comprising:
a compressor, a first heat-exchanger, a second heat-exchanger, a first expansion valve, and a third heat-exchanger, connected through a refrigerant line to circulate a refrigerant;
a first connection line including a first end connected to the refrigerant line connecting the second heat-exchanger and the first expansion valve and a second end connected to the refrigerant line connecting the third heat-exchanger and the compressor;
a chiller provided on the first connection line, the chiller configured to adjust a temperature of a coolant by exchanging heat between the refrigerant and the coolant;
a second expansion valve provided on the first connection line between the first end of the first connection line and the chiller;
a second connection line including a first end connected to the refrigerant line between the first heat-exchanger and the second heat-exchanger and a second end connected to the first connection line between a second end of the first connection line and the chiller; and
a third connection line including a first end connected to the refrigerant line between the compressor and the first heat-exchanger and a second end connected to the refrigerant line between the first heat-exchanger and the second heat-exchanger.

2. The heat pump system of claim 1, further comprising:
a first valve provided on the refrigerant line between the compressor and the first heat-exchanger;
a second valve provided on the refrigerant line between the first heat-exchanger and the second heat-exchanger;
a third valve provided on the first connection line between the second end of the first connection line and the chiller;
a third expansion valve provided on the second connection line; and
a fourth valve provided on the third connection line.

3. The heat pump system of claim 2, further comprising:
a fourth connection line including a first end connected to the refrigerant line between the third heat-exchanger and the compressor and a second end connected to the refrigerant line between the second valve and the second heat-exchanger; and
a fifth valve provided on the fourth connection line.

4. The heat pump system of claim 3, wherein, when a battery module is to be cooled in a cooling mode of a vehicle interior:
a portion of the refrigerant line connecting the compressor and the first heat-exchanger, and a portion of the refrigerant line connecting the first heat-exchanger and the second end of the third connection line are configured to be closed by the first valve;
a remaining portion of the refrigerant line connecting the second end of the third connection line to the second heat-exchanger, the third heat-exchanger, and the compressor is configured to be opened by the second valve and the first expansion valve;
the first connection line is configured to be opened by the second expansion valve and the third valve;
the second connection line is configured to be closed by the third expansion valve;
the third connection line is configured to be opened by the fourth valve; and
the fourth connection line is configured to be closed by the fifth valve.

5. The heat pump system of claim 4, wherein:
the first expansion valve is configured to allow the introduced refrigerant to flow in an expanded state;
the second expansion valve is configured to allow the introduced refrigerant to flow in an expanded state so that the battery module may be cooled by using the coolant heat-exchanged with the refrigerant in the chiller;
the refrigerant discharged from the compressor is introduced into the second heat-exchanger along the third connection line and the opened refrigerant line;
a partial refrigerant among the refrigerant discharged from the second heat-exchanger is introduced into the chiller along the first connection line;
a remaining refrigerant among the refrigerant discharged from the second heat-exchanger is introduced into the first expansion valve along the refrigerant line; and
the refrigerant discharged from the chiller, and the refrigerant discharged from the third heat-exchanger are supplied to the compressor along the refrigerant line.

6. The heat pump system of claim 3, wherein, in a cooling-and-dehumidifying mode of a vehicle interior:
the refrigerant line connecting the compressor, the first heat-exchanger, the second heat-exchanger, the first expansion valve, and the third heat-exchanger is configured to be opened by the first valve, the second valve, and the first expansion valve;
the first connection line is configured to be closed by the second expansion valve and the third valve;
the second connection line is configured to be closed by the third expansion valve;
the third connection line is configured to be closed by the fourth valve; and
the fourth connection line is configured to be closed by the fifth valve.

7. The heat pump system of claim 6, wherein:
the first expansion valve is configured to allow the introduced refrigerant to flow in an expanded state; and
the refrigerant discharged from the compressor is configured to flow along the refrigerant line to sequentially pass through the first heat-exchanger, the second heat-exchanger, and the third heat-exchanger.

8. The heat pump system of claim 3, wherein, when an ambient air heat is to be recollected and a battery module is to be heated in a heating mode of a vehicle interior:
a portion of the refrigerant line connecting the compressor and the first heat-exchanger is configured to be opened by the first valve;
a portion of the refrigerant line connecting the first end of the second connection line to the second end of the fourth connection line is configured to be closed by the second valve;
a portion of the refrigerant line connecting the second end of the first connection line to the first end of the fourth connection line is configured to be closed by the first expansion valve;
a portion of the refrigerant line connecting the second end of the fourth connection line to the first end of the first connection line is configured to be opened;
a portion of the first connection line is configured to be opened by the second expansion valve so that the first end of the second connection line is connected to the second heat-exchanger through the refrigerant line;
a remaining portion of the first connection line is configured to be closed by the third valve;
the second connection line is configured to be opened by the third expansion valve;
the third connection line is configured to be closed by the fourth valve; and
the fourth connection line is configured to be opened by the fifth valve.

9. The heat pump system of claim 8, wherein:
the chiller is configured to exchange heat between the refrigerant and the coolant introduced from the battery module;
the second expansion valve is configured to allow the refrigerant introduced from the chiller through a portion of the first connection line to flow in an expanded state;
the third expansion valve is configured to allow the introduced refrigerant to flow without expansion;
the refrigerant having passed through the first heat-exchanger from the compressor is introduced into the chiller along the second connection line and a portion the first connection line;
the refrigerant discharged from the chiller is introduced into the second heat-exchanger along a portion of the refrigerant line in an expanded state, expanded in the second expansion valve; and
the refrigerant discharged from the second heat-exchanger is supplied to the compressor along the fourth connection line and the opened portion of the refrigerant lines.

10. The heat pump system of claim 3, wherein, when an ambient air heat and a waste heat of an electrical component is to be recollected in a heating mode of a vehicle interior:
a portion of the refrigerant line connecting the compressor and the first heat-exchanger is configured to be opened by the first valve;
a portion of the refrigerant line connecting the first end of the second connection line to the second end of the fourth connection line is configured to be closed by the second valve;
a portion of the refrigerant line connecting the first end of the first connection line to the first end of the fourth connection line is configured to be closed by the first expansion valve;
a portion of the refrigerant line connecting the second end of the fourth connection line to the first end of the first connection line is configured to be opened;
a portion of the first connection line is configured to be opened by the second expansion valve so that the first end of the second connection line is connected to the second heat-exchanger through the refrigerant line;
a remaining portion of the first connection line is configured to be closed by the third valve;
the second connection line is configured to be opened by the third expansion valve;
the third connection line is configured to be closed by the fourth valve; and
the fourth connection line is configured to be opened by the fifth valve.

11. The heat pump system of claim 10, wherein:
the chiller is configured to exchange heat between the refrigerant and the coolant introduced from the electrical component;
the second expansion valve is configured to allow the refrigerant introduced from the chiller through a portion of the first connection line to flow without expansion;
the third expansion valve is configured to allow the introduced refrigerant to flow in an expanded state;
the refrigerant having passed through the first heat-exchanger from the compressor is introduced into the chiller along the second connection line and a portion of the first connection line;
the refrigerant discharged from the chiller is introduced into the second heat-exchanger along the opened portion of the first connection line and a portion of the refrigerant line; and
the refrigerant discharged from the second heat-exchanger is supplied to the compressor along the fourth connection line and the opened portion of the refrigerant lines.

12. The heat pump system of claim 3, wherein, when a waste heat of an electrical component is to be recollected in a heating-and-dehumidifying mode of a vehicle interior:
a portion of the refrigerant line connecting the compressor and the first heat-exchanger is configured to be opened by the first valve;
a portion of the refrigerant line connecting the first end of the second connection line to the second end of the fourth connection line is configured to be closed by the second valve;
a portion of the refrigerant line connecting the first end of the first connection line to the first end of the fourth connection line is configured to be opened by the first expansion valve;
a portion of the refrigerant line connecting the second end of the fourth connection line to the first end of the first connection line is configured to be closed;
a portion of the first connection line is configured to be opened by the second expansion valve so that the first end of the second connection line is connected to the first expansion valve through the refrigerant line;
a remaining portion of the first connection line is configured to be closed by the third valve;
the second connection line is configured to be opened by the third expansion valve;
the third connection line is configured to be closed by the fourth valve; and
the fourth connection line is configured to be closed by the fifth valve.

13. The heat pump system of claim 12, wherein:
the first expansion valve is configured to allow the introduced refrigerant to flow without expansion;
the chiller is configured to exchange heat between the refrigerant and the coolant introduced from the electrical component;
the second expansion valve is configured to allow the refrigerant introduced from the chiller through a portion of the first connection line to flow without expansion;
the third expansion valve is configured to allow the introduced refrigerant to flow in an expanded state;
the refrigerant having passed through the first heat-exchanger from the compressor is introduced into the chiller along the second connection line and a portion the first connection line;
the refrigerant discharged from the chiller passes through the first expansion valve along the opened portion of the first connection line and a portion of the refrigerant line, to be introduced into the third heat-exchanger; and
the refrigerant discharged from the third heat-exchanger is supplied to the compressor along the opened portion of the refrigerant line.

14. The heat pump system of claim 3, wherein the first valve, the second valve, the third valve, the fourth valve, and the fifth valve are check valves configured to allow the refrigerant flowing in a corresponding line to flow in only one direction.

15. The heat pump system of claim 2, wherein the first expansion valve, the second expansion valve, and the third expansion valve are electronic expansion valves configured to selectively expand the refrigerant while controlling a flowing movement of the refrigerant.

16. The heat pump system of claim 1, further comprising an accumulator provided on the refrigerant line between the third heat-exchanger and the compressor.

17. The heat pump system of claim 1, wherein the second heat-exchanger and the chiller are configured to cool or evaporate the refrigerant.

18. The heat pump system of claim 1, wherein:
the first heat-exchanger, the second heat-exchanger, and the third heat-exchanger are air-cooled gas coolers configured to exchange heat between the refrigerant and air; and
the chiller is a water-cooled gas cooler configured to exchange heat between the refrigerant and the coolant.

19. The heat pump system of claim 1, wherein the refrigerant is a R744 refrigerant formed of carbon dioxide.

20. The heat pump system of claim 1, wherein the chiller is connected to an electrical component and a battery module through a first line and a second line through which a coolant circulates.
